(19) United States
(12) Patent Application Publication
(10) Pub. No.: US 2007/0283363 A1
(43) Pub. Date: Dec. 6, 2007

(54) Method For Managing Events

(76) Inventor: Horst Nather, Villingen-Schwenningen (DE)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 11/574,637

(22) PCT Filed: Aug. 3, 2005
(86) PCT No.: PCT/EP05/53797

§ 371 Date: Mar. 2, 2007

(30) Foreign Application Priority Data
Sep. 2, 2004 (DE) 10 2004 042 940.5

(51) Int. Cl. G06F 9/44

(52) U.S. Cl. 719/318

(57) ABSTRACT

A method for managing event entries (ABC, XYZ), which are assigned to events, by means of a digital tachograph (1) electronically records personal data concerning the operation of a commercial vehicle. Conventional methods are very limited in their capabilities, particularly with regard to influencing by a user. A solution for this is provided by virtue of the fact that events of basic components (BK1, BK2, BK3) are entered in a central event memory (2) with a priority (P1, P2), and an event module (3) selects events and furnishes them to a subsequent processing.

### CROSS-REFERENCE TO RELATED APPLICATIONS

This application is a U.S. national stage application of International Application No. PCT/EP2005/053797 filed Aug. 3, 2005, which designates the United States of America, and claims priority to German application number DE 10 2004 042 940.5 filed Sep. 2, 2004, the contents of which are hereby incorporated by reference in their entirety.

### TECHNICAL FIELD

The invention relates to a method for managing event entries, which are assigned to events, by means of a digital tachograph for electronically recording personal data which relates to the operation of a utility vehicle.

### BACKGROUND

During the operation of a tachograph, the main objective is to record a vehicle velocity as a function of time and to record activities in relation to one or more persons. The significant element here is to monitor driving times, rest periods etc. in order to monitor compliance with legal requirements. In this context, several events may occur, for example faults in the recording, cyclical transmission of a measured value, correlated to the velocity, to the recording element, or the activation of operator-controlled elements for controlling the recording process. In the days of mechanical tachographs, such events were essentially processed independently of one another, and the operator frequently created a dependence directly at the level of the recording. In addition, the functional quality of the mechanical device permitted only a less differentiated measurement of, for example, system faults or measurement errors and the user was only provided with a selection of functions which was restricted to the essentials. When an event occurred which made it necessary for the user to intervene in the recording device, the recording device or the tachograph merely gave the user an undifferentiated message so that the details of the rest of the operator-controlled process had to be determined by the user by virtue of his operating competence. Compared to the conventional devices, the new, digital generation of tachographs makes available a much more differentiated functionality. Dedicated fault messages and action instructions direct the user through a menu-prompted operator control system when corresponding events occur. In particular, in terms of the possibilities for evaluating the recordings, the driver of the utility vehicle is provided with completely new functions so that, for example, he is alerted automatically to the need for a break time according to legal stipulations. Furthermore, novel safety mechanisms reliably prevent illegitimate attempts at tampering from being successful. The highly extended functional scope and the increased complexity of the entire arrangement composed of the tachograph, velocity sensor and further connected devices increases the vulnerability to events which can be taken into account.

The velocity sensor is a wheel speed sensor, generally referred to as a motion sensor, which supplies pulses as a measure of the wheel speeds from which the tachograph calculates the distance covered by the vehicle by means of a constant value for the circumference of the wheels, and determines the velocity therefrom at defined time intervals.

### SUMMARY

The invention therefore has the object of providing a method which feeds events of the abovementioned type to a means for taking them into account, in particular further processing, in a way which is appropriate chronologically and in accordance with priorities.

According to an embodiment, a method for managing event entries which are assigned to events, by means of a digital tachograph for electronically recording personal data which relates to the operation of a utility vehicle, may comprise the steps of:
entering events with a priority in a central event memory as event entries of basic components,
searching the event memory by an event module at regular time intervals for the event entry with the highest priority, and selecting the event entry with the highest priority,
assigning a control parameter by the event module to the event of the selected event entry by means of a control parameter table, and
as a function of the control parameter
initiating a memory entry, assigned to the event of the event entry, in a vehicle memory, or
transmitting control signals to another component by means of a car area network, or
preparing an output at a printer, or
initiating representation on a display, or
bringing about data transmission to an external data memory.

### BRIEF DESCRIPTION OF THE DRAWINGS

The invention will be described in more detail below for the sake of clarity by means of an exemplary embodiment and with reference to a drawing, in which:

FIG. 1: is a schematic illustration of the method by means of a flowchart.

### DETAILED DESCRIPTION

Event entries within the sense of the invention are to be understood as electronic recordings which are entered using a predefined naming convention, in particular with specification of the event time in an electronic memory, specifically the central event memory. The entry process is carried out here by basic components which virtually independently of one another register events, for example the transmission of a measured value from a rotational speed sensor or movement sensor or recording error or safety infringements or the requirement for a breaktime and enter these events as event entries in the event memory. In this context, the events are preferably assigned a priority by the basic components, said priority resulting from a superordinate priority convention as a function of the type of event. An event module which is implemented using software cyclically searches the event memory for event entries and selects that event entry with the highest priority in order to provide it with a control parameter. The event entry is further processed as a function of the control parameter in such a way that a memory entry which is assigned to the event used as the basis is initiated or generated from the event entry in a vehicle memory, or control signals are transmitted to a connected component by means of a car area network, or outputting can be initiated at an attached printer, or representation on a display is initiated, or data transmission to an external data memory is brought about. The particular advantage of the embodiments is that events are taken into account at any time without the highly loaded main processor of the tachograph being burdened at an inappropriate time, and in a way which puts stability at risk, with the processing of the processes initiated by the events. The central event memory acts here as a time buffer and permits controlled and planned execution of the processes which are initiated by means of the events, particular synergy effects, which reduce the utilization factor of the central processor of the tachograph to the minimum necessary, occurring by virtue of the prioritization according to an embodiment when the event entries are stored in the event memory.

One particularly embodiment provides for the control table to contain control parameters as a function of an event reference number which is assigned to the event entry. The event reference number can comprise here merely a designation of the event entry or an attribute which is assigned to the event entry or the event. In the case of changes in the further processing of event entries, particular flexibility is found to occur since here only entries in the control table have to be changed. The method according to an embodiment can advantageously provide that the basic components access an assignment function which assigns a priority to the event entries. This assignment function is preferably here a subject of the central access so that changes relating to the priority of the handling of an event or event entry can be implemented with minimum expenditure, without having to make changes to the basic components.

In order to minimize the expenditure when searching the event memory for the event entry with the highest priority, it is expedient if the central event memory has a uniquely defined assignment of memory locations for event entries to priorities. In this way, the event entries of the basic components are performed by the assignment function in accordance with the priority at only one specific memory location of the event memory, and the event module searches the memory locations only once more in a sequential fashion with decreasing assigned priority for the first allocation of an event entry without firstly having to compare all the event entries with respect to their priority. As a result of the fixed memory location of an event which is defined by their priority, a specific event is always written into the same memory location. Owing to the fixed assignment of priorities to memory locations, no priority conflicts can occur. In addition, this provides the possibility that the message can easily be ignored if an event with a duration is signaled repeatedly while it has not yet ended. If the same event is signaled again after it has already been ended, this is registered by incrementing the event counter. In no case must the basic component wait until the memory location becomes free again.

Events or event entries with the same priority are thus fed to further processing, or provided with a control parameter, in a chronological sequence of their occurrence by the event module.

The method according to an embodiment is particularly expediently developed if the event module assigns attributes to the event entries as a function of the memory location by means of an attribute table. The assigned attributes can pass on supplementary information to subsequent processing steps, for example to printing out or outputting on a display.

In particular within the scope of the application according to an embodiment it is important that the memory entries to be made according to legal requirements satisfy stability criteria which apply to the vehicle memory or to a chip card so that it is advantageous if the event module initiates the entry of a memory entry which is assigned to the event of the event entry in the vehicle memory in which it transfers the event entry to a memory module which enters a memory entry, assigned to the event, into a vehicle memory.

It is also of particular importance for the application within the scope of a digital tachograph to record events with a duration during which the basic component which is entered into the event memory enters the start of the event and the end into the event memory, and the event module assigns the same time value to the end of the event as to the start if an end has not been entered by the basic components because specific events do not have any duration according to their definition. A particular advantage of the assignment of the same time value to the start and to the end is the avoidance of subsequent errors.

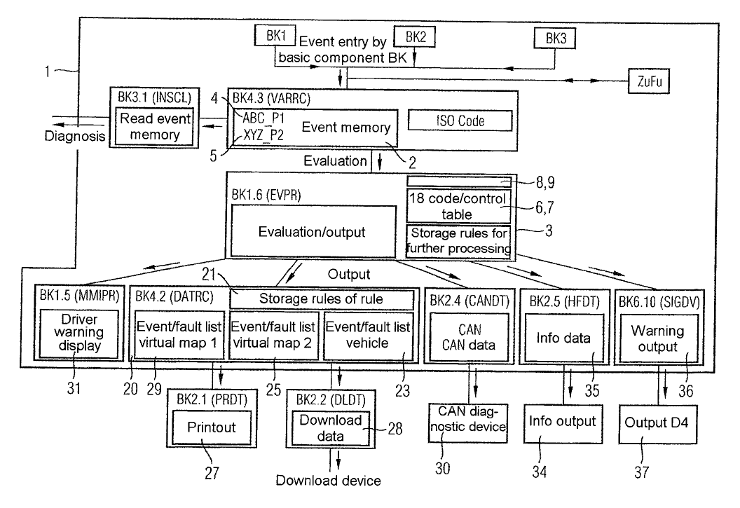

FIG. 1 shows the basic sequence and the interaction between various components according to the method. A tachograph 1 is symbolized by means of a system limit which is provided with the reference symbol 1. Various basic components BK1, BK2, BK3 have writing access to an event memory 2 in which the basic components BK1, BK2, BK3 make an event entry ABC, XYZ in the event memory 2 when an event, for example the request for a representation on a display, occurs. The event entry ABC, XYZ is provided here with a priority P1, P2 by the basic components by accessing an assignment function ZuFu.

The basic components BK1, BK2, BK3 enter events as event entries ABC, XYZ in the central event memory 2 as “pending” when they occur, and as “terminated” when they end. Here, each event entry XYZ, ABC is composed of a status, an event counter and a starting time marker and an end time marker. The event counter is used for statistical purposes. The status includes the bit flags “pending”, “terminated”, “event active”, “start-LCD”, “active-LCD” and “cyclic event”.

An event module 3 searches the event memory 2 for the event entry ABC, XYZ with the highest priority P1, P2. The event entries ABC, XYZ in the event memory 2 have a uniquely defined assignment to a memory location 4, 5 as a function of their priority P1, P2 so that the event module 3 passes through the individual memory locations 4, 5 only in the sequential sequence of decreasing priority P1, P2 and feeds the event entry ABC, XYZ of the first occupied memory location 4, 5 to further processing.

In the scope of the further processing the event module 3 assigns the event entry ABC, XYZ a control parameter 6 from a control parameter table 7 and attributes 8 from an attribute table 9.

The event entry ABC, XYZ which is expanded with attributes 8 and a control parameter 6 is fed by the event module 3 to an output means, a storage means, a transfer means or a further processing means. If the control parameter 6 provides for outputting, the expanded event entry ABC, XYZ is transferred to an output module 20 which also comprises a memory module 21 which controls storage of a memory entry, based on the event entry ABC, XYZ, in a vehicle memory 23 or a map memory 24, 25. The map memories 24, 25 are both components of the tachograph 1 and are embodied as merely virtual chip cards, that is to say memory areas in the tachographs 1 are occupied by identical data entries, like an actual chip card which is introduced into the tachograph 1 for the purpose of recording. If an event is to be output on a printer 27, the output module 20 feeds the expanded event entry ABC, XYC to the printer 27 a corresponding actuation. In addition, the output module 20 permits a data download by means of a connected download module 28. The data can be transmitted from the event module 3 to other components 30 by means of the car area network CAN. Furthermore, the event module 3 permits outputting on a display 31 of the tachograph 1. The possibility of connecting further output devices 34 is provided by an info module 35 which is connected to the event module 3. By means of a warning module 36 the event module 3 can output warning messages, for example on a combination instrument 37.

What is claimed is:

1. A method for managing event entries which are assigned to events, by means of a digital tachograph for electronically recording personal data which relates to the operation of a utility vehicle, the method comprising the steps of:
entering events with a priority in a central event memory as event entries of basic components,
searching the event memory by an event module at regular time intervals for the event entry with the highest priority, and selecting the event entry with the highest priority,
assigning a control parameter by the event module to the event of the selected event entry by means of a control parameter table, and
as a function of the control parameter
initiating a memory entry, assigned to the event of the event entry, in a vehicle memory, or
transmitting control signals to another component by means of a car area network, or
preparing an output at a printer, or
initiating representation on a display, or
bringing about data transmission to an external data memory.

2. The method according to claim 1, wherein the control parameter table contains control parameters as a function of an event reference number which is assigned to the event entry.

3. The method according to claim 1, wherein the basic components access an assignment function which assigns a priority to the event entries.

4. The method according to claim 3, wherein the central event memory has a uniquely defined assignment of memory locations for event entries to priorities.

5. The method according to claim 4, wherein the event module assigns attributes to the event entries as a function of the memory location by means of an attribute table.

6. The method according to claim 1, wherein the event module initiates the entry a memory entry assigned to the event of the event entry in the vehicle memory by transferring the event entry to a memory module by which a memory entry assigned to the event is entered into a vehicle memory.

7. The method according to claim 1, wherein, in the case of events with a duration, the basic component which makes entries into the event memory enters the start of the event and the end in the event memory, and the event module assigns the same time value to the end of the event as to the start if an end has not been entered by the basic component.

8. The method according to claim 1, wherein in the case of events which are classified as difficult or faults, a “cyclical” control parameter is assigned, said control parameter bringing about repeating symbolic representation on the display at regular time intervals.

9. A digital tachograph for managing event entries which are assigned to events and for electronically recording personal data which relates to the operation of a utility vehicle, comprising:
a central event memory for receiving and storing events with a priority as event entries of basic components,
an event module operable to search the event memory at regular time intervals for the event entry with the highest priority, and to select the event entry with the highest priority,
wherein the event module is further operable to assign a control parameter to the event of the selected event entry by means of a control parameter table, and as a function of the control parameter is further operable to:
initiate a memory entry, assigned to the event of the event entry, in a vehicle memory, or
transmit control signals to another component by means of a car area network, or
prepare an output at a printer, or
initiate representation on a display, or
bring about data transmission to an external data memory.

10. The digital tachograph according to claim 9, wherein the control parameter table contains control parameters as a function of an event reference number which is assigned to the event entry.

11. The digital tachograph according to claim 9, wherein the basic components access an assignment function which assigns a priority to the event entries.

12. The digital tachograph according to claim 11, wherein the central event memory has a uniquely defined assignment of memory locations for event entries to priorities.

13. The digital tachograph according to claim 12, wherein the event module is operable to assign attributes to the event entries as a function of the memory location by means of an attribute table.

14. The digital tachograph according to claim 9, wherein the event module is operable to initiate the entry a memory entry assigned to the event of the event entry in the vehicle memory by transferring the event entry to a memory module by which a memory entry assigned to the event is entered into a vehicle memory.

15. The digital tachograph according to claim 9, wherein, in the case of events with a duration, the basic component which makes entries into the event memory is operable to enter the start of the event and the end in the event memory, and the event module assigns the same time value to the end of the event as to the start if an end has not been entered by the basic component.

16. The digital tachograph according to claim 9, wherein in the case of events which are classified as difficult or faults, a “cyclical” control parameter is assigned, said control parameter bringing about repeating symbolic representation on the display at regular time intervals.
